(19) United States
(12) Patent Application Publication
(10) Pub. No.: US 2008/0071764 A1
(43) Pub. Date: Mar. 20, 2008

(54) Method and an apparatus to perform feature similarity mapping

(76) Inventors: Kazunari Omi, Osaka (JP); Ian S. Wilson, Yokohama (JP); Arka N. Roy, Tokyo (JP)

Correspondence Address: Judith A. Szepesi;BLAKELY, SOKOLOFF, TAYLOR & ZAFMAN LLP, Seventh Floor, 12400 Wilshire Boulevard, Los Angeles, CA, 90025, US

(21) Appl. No.: 11/524,068

(22) Filed: Sep. 19, 2006

(51) Int. Cl. G06F 17/30

(52) U.S. Cl. 707/5

(57) ABSTRACT

A method and an apparatus to perform feature similarity mapping are presented. In one embodiment, the method includes mapping a set of data items onto a feature similarity matrix (FSM) in a feature similarity system. The FSM has multiple dimensions (generally ten or more). Each item has a number of features and each of the features maps to a distinct matrix node weight. The method may further include positioning of data in the FSM, the position of data corresponding to one or more items having one or more features similar to one or more of the features of the items mapped to FSM nodes in close proximity.

### TECHNICAL FIELD

The present invention relates to computerized searching techniques, and more particularly, to feature similarity mapping.

### BACKGROUND

Recommendation services or search engines are becoming more and more popular and useful in everyday life. Users often find it convenient to receive recommendations on items that the users may be interested in. For example, users may want to receive recommendations of items, such as books, music, movies, news, places, restaurants, etc., that are similar to those of the users' own taste or preferences or to those the users have found interesting. In this document, an item refers to person, place, thing, idea, etc. which may be specified separately in a group of items that could be enumerated in a list. An item is defined by a number of characteristics or traits, which are referred to as features in the following discussion.

Various recommendation services and/or search engines are available over the Internet to help users find items. Most conventional recommendation services generally rely on a comparison of a user's activity or past behaviors with that of other customers. Others rely on editor recommendations.

Some recommendation services use automatic recommendation engines, but generally such services evaluate a single feature of items. These engines select a subset of the items to recommend to a user if the single feature of the subset of items matches the corresponding feature of an item which the user has indicated to be interesting. In the following discussion, the item that the user has indicated to be interesting is referred to as a sample. For example, a restaurant recommendation service may recommend to a user restaurants specializing in the same type of cuisine as a restaurant visited by the user. A movie recommendation service may recommend to a user a thriller movie if the user has recently rented another thriller movie.

Many conventional recommendation services and/or search engines find items potentially interesting to a user by matching only one feature of a sample provided by the user to the corresponding feature of other items. An item is recommended to the user only if the feature of the sample exactly matches the corresponding feature of the item. In other words, these conventional recommendation services do not consider variability within a feature. However, many features of thousands of items may vary across a wide range, such as the audio frequency in music, the shade of a color, etc. Limited by the number of features to be evaluated and the failure to allow variability within a feature, many conventional recommendation services and/or search engines may not recommend items across different categories in response to a single request and the recommendation made may not be truly tailored to a user's taste or preferences.

### SUMMARY

The present invention includes a method and an apparatus to perform feature similarity mapping. In one embodiment, the method includes mapping a set of data items selected for searching onto a feature similarity matrix (FSM) having a plurality of dimensions (generally ten or more) and a plurality of matrix nodes, each node having a plurality of node weights. Furthermore, each item has a plurality of features and each of the node weights corresponds to a distinct one of the plurality of features. The method may further include positioning data in the FSM, the positions of data corresponding to one or more items having one or more features similar to one or more of the plurality of features of the item.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 illustrates a flow diagram of one embodiment of a process to perform feature similarity mapping;

FIG. 2 illustrates one embodiment of a process to convert input feature data to a normal distribution of relative values;

FIG. 3 illustrates one embodiment of a process to configure a data similarity system having a feature similarity matrix (FSM);

FIG. 4 illustrates one embodiment of a process to discover data clusters within a multi-dimensional FSM in a feature similarity system;

FIG. 5 illustrates one embodiment of a process to separate data clusters within a multi-dimensional FSM in a feature similarity system;

FIG. 6 illustrates one embodiment of a process to convert ordinal position values of items to be output from a feature similarity system into normally distributed relative values;

FIG. 7 illustrates a functional block diagram of one embodiment of system to perform feature similarity mapping; and

FIG. 8 illustrates one embodiment of a computing system usable to perform feature similarity mapping.

### DETAILED DESCRIPTION

A method and an apparatus to perform feature similarity mapping are described. In the following description, numerous specific details are set forth. However, it is understood that embodiments of the invention may be practiced without these specific details. In other instances, well-known components, structures, and techniques have not been shown in detail in order not to obscure the understanding of this description.

In some embodiments, an item is mapped onto a feature similarity matrix (FSM), which has a plurality of dimensions (generally ten or more). The item is an object defined by many features. Each of the weights of the nodes of the FSM corresponds to a distinct one of the item's features. After mapping the item onto the FSM, a unique position in the FSM is identified. The weight values of the matrix node closest to the unique position may be, as a whole, closest to the values of the features of the item. Many of the technical terms used above are further defined below before the details of some embodiments are discussed.

### Definitions of Terms

### Feature Similarity Matrix (FSM)

A feature similarity matrix (FSM) is a matrix having multiple dimensions usable in searching for similar items. The FSM includes a number of nodes. In other words, the FSM may be viewed as a collection of nodes.

### Dimensions

Dimensions of the FSM are the parameters used to describe the position of a node within the FSM. In some embodiments, the number of dimensions of the FSM is the total number of different parameters used to determine the position of nodes in the FSM. Each node is represented by a set of coordinates, one of each in every dimension of the FSM.

### Levels

Levels are nominal scale numbers (i.e., positive integer numbers) assigned to the dimensions of the FSM to represent positions of the nodes along a particular dimension. The number of levels in a dimension may range from two (2) to any arbitrary positive number greater than 2. For example, a 2-level dimension of a FSM would have positional values of 0 and 1 only.

### Matrix Node Position

A matrix node position is the position of a node within the FSM. The matrix node position is defined by a level value in each dimension of the FSM. For example, if a FSM has five (5) dimensions and two (2) levels per dimension, then the position of a node is defined by 5 level values, where each level value may be 0 or 1. For instance, one of the nodes in the above matrix may be [1, 0, 0, 1, 1].

### Weight Values

Each node has a number of weight values. The number of weight values is equal to the number of input data features, with one weight value corresponding to one input data feature value. As the FSM is a collection of nodes, the node matrix position and the weight values of each of the nodes represent the FSM as a whole.

### Input Data

Input data corresponding to an item is represented by a set of feature values.

These values may be any arbitrary type of numeric data. In one embodiment, these values are positive integers. These features and their values may be referred to as “attribute-value” pairs. In one embodiment, each item in a given set of items has the same number of features and the position in the representation of each feature (e.g., the first feature, second feature, etc.) remains the same for all items within the set. For instance, the feature values of a first item in a set of items having five features may be represented by [0.123, 10045, 62, 77.7, −2.24] and the feature values of a second item within the same set of items may be represented by [0.204, 11055, 60, 70.8, −3.34], where the feature of the first item having the value of 0.123 is the same feature of the second item having the value of 0.204, the feature of the first item having the value of 10045 is the same feature of the second item having the value of 11055, and so on. In one embodiment, features for which no data is available are represented by a zero in order to ensure that position representation remains the same.

### Output Data

Like input data, output data of an item is also represented by a set of feature values. In some embodiments, these values are ordinal, relative scale, and normally distributed (i.e., distributed according to a Gaussian distribution). The data of each item in the set of items may have the same number of features and the position in the representation of each feature may be the same for all items within the same set.

Relative scale, also referred to as interval scale, is a range of values that is fixed between certain predetermined limits. In some embodiments, the range may range from minus infinity to positive infinity. However, if the values within the range rarely go beyond some predetermined limits, such as −0.5 and +0.5, then one may refer to (−0.5-+0.5) as the effective limit of the relative scale.

A Z score is a dimensionless value derived by subtracting the population mean from an individual (also referred to as raw) score and then dividing the difference by the population standard deviation. The conversion process is also known as “standardization.”

### Details of Some Embodiments

In some embodiments of a feature similarity mapping system, there are two modes of operations, namely, a learning mode and a production mode. The similarity mapping system may be substantially the same in both the learning mode and the production mode, except that the weight values are fixed in the production mode. In the learning mode, the system is presented with a large number of sample items from which the corresponding matrix node weights in a FSM arrange themselves until each of at least a predetermined portion of the sample items are mapped to one matrix node. At this point, the node weights are fixed and the system may transition into the production mode. In the production mode, one or more items may be mapped to the FSM, where a particular item may always be mapped to the same node in the FSM since the matrix node weights in the FSM have been fixed.

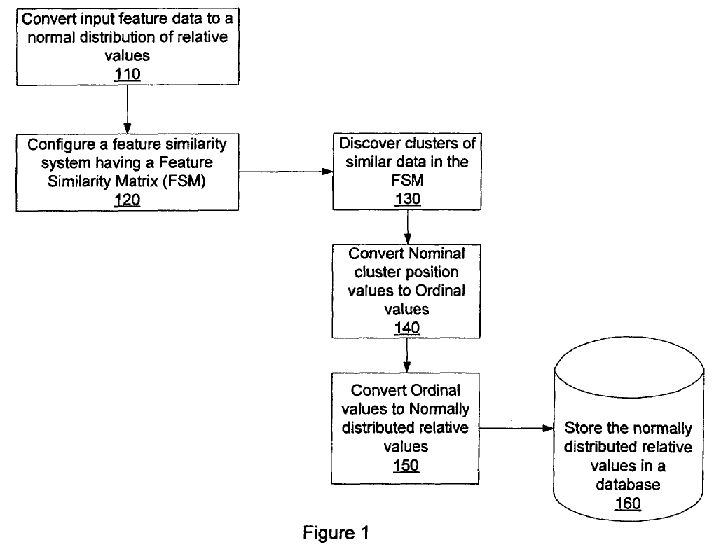

FIG. 1 shows a flow diagram of one embodiment of a process to perform feature similarity mapping in the learning mode. The process depicted in FIG. 1, as well as other processes depicted in other figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

In some embodiments, processing logic receives an item that a user is interested in from the user. In other words, the item may be viewed as a sample of the items that the user may be interested in. Thus, the item is hereinafter referred to as a sample. Note that the user may provide more than one sample and the technique described below may be readily extended to process multiple samples. In one embodiment, the sample may not be received from a user, but either automatically generated, or otherwise created. The sample is defined by a number of features, which are characteristics or traits of the sample. For example, the sample may be a piece of music and the features of the piece of music may include pitch, timbre, tempo, frequencies, beat strength, power spectrum, etc. Furthermore, some of the features may have different ranges. The values of the features of the sample are collectively referred to as input feature data.

Referring to FIG. 1, processing logic converts input feature data to a normal distribution of relative values (processing block 110). In other words, the input feature data is normalized or scaled to be within the same standard, normally distributed relative scale. To normalize the feature data, processing logic may use Z score. Details of one embodiment of the process to normalize the feature data are discussed below.

By normalizing the input feature data to a normal distribution of relative values, the range of values for a feature of the sample is adjusted to be within the range of other input data sets. This enables the use of the same feature similarity system to process different input data sets as described below. Note that this technique may be independent of what the features of the sample actually represent in the real world as long as those features are represented numerically. In one embodiment, normalizing the input feature data converts the input feature data of each feature into the same range of values. As a result, the FSM may treat each feature substantially identically and hence, may not bias any particular feature. As such, more consistent feature similarity mapping may be produced and the normalized input feature data is also much easier to process. In addition, because the normalized input feature data is within the same range, operations, such as calculations, comparisons, etc., may be performed between different dimensions of the FSM (a.k.a. inter-dimensional operations) as described below.

In addition to the above advantages, normalizing the input feature data may help to prevent a single feature value having a low probability of occurrence from skewing the entire set of feature values. In other words, the problem of feature distortion due to data value “bunching” may be substantially removed. By normalizing the input feature data to be within a range, the probability of occurrence of the feature values is accounted for by the locations of the feature values within the range. For example, a set of feature values may have a high probability of occurrence within the range of 0 to 10, whereas a feature value of 10000 may have a very low probability of occurrence. By normalizing the set of feature values including a large number of feature values within 0 to 10 and a single feature value of 10000, feature distortion due to the single feature value of 10000 may be substantially removed.

After normalizing the input feature data, processing logic configures a feature similarity system having a FSM (processing block 120). More details of some embodiments of a process to configure the feature similarity system are discussed below. In order to organize and process the normalized input feature data in an efficient way, the feature similarity mapping system uses a FSM having multiple dimensions.

By using a FSM having multiple dimensions (e.g., 5, 12, etc.), more information of the sample is retained for analysis, because each dimension of the FSM corresponds to a feature of the sample. Because more information of the sample is retained, the output data from the FSM may be better processed by subsequent applications. As a result, analysis by the subsequent applications may yield more useful additional information. Furthermore, by using many dimensions for processing and subsequent output, data may be separated according to more features than conventional techniques. Thus, more accurate separation of data may be achieved, as well as more accurate clustering of similar items. One embodiment of the details of data clustering is described below.

Initially, a collection of items may be mapped to the FSM based on the feature values of the items. These items are represented as clusters of data in the FSM. Using the FSM, processing logic identifies clusters of data in the FSM having features similar to the sample (processing block 130). In some embodiments, processing logic maps the sample to the FSM, and then identifies one or more clusters of data in proximity to the location of the sample in the FSM. In one embodiment, processing logic may map the sample to the FSM using the normalized input feature data of the sample. For each node of the FSM, processing logic may determine which node weight value is closest to the corresponding normalized feature value of the sample. After determining the cumulative difference in value between each item feature and corresponding node weight, the matrix node with the smallest cumulative difference in the FSM is found and the sample is mapped to the FSM by associating the matrix node position with the sample. More details of mapping a sample to the FSM are discussed below.

In some embodiments, positions of the clusters of data are in nominal scale values. The clusters of data may be further separated. More details of separating clusters of data are discussed later. Then processing logic converts nominal cluster position values to ordinal values (processing block 140). The cluster position values may be converted from variable nominal scale values into relative ordinal scale values with a normal distribution. Alternatively, the cluster position values may be converted from nominal scale values into ordinal scale values. For example, if a five dimensional output value of [2, 4, 5, 3, 1] is output from processing block 130, conversion to an ordinal scale may produce an output value of [2.34, 3.98, 5.54, 3.12, 1.34]. Note that the ordinal values, which are real numbers having two-decimal place in the current example, are more accurate than the nominal values, which are integers. In another example, four decimal place values may be used to improve the accuracy of positioning. More details of some embodiments of the conversion are described below.

Conversion of the nominal values to ordinal values may allow for further statistical analysis of the output data since most statistical analyses are performed on real numbers, not nominal values. Each output data item is likely to have a unique identifying position and the use of real number ordinal values makes a range of further processing options possible. One example of the further processing options is to process the ordinal values using an agent system, which is described in details in the co-pending patent application, U.S. patent application Ser. No. ______, entitled A METHOD AND AN APPARATUS TO PERFORM FEATURE WEIGHTED SEARCH AND RECOMMENDATION, filed of even date with this application.

Processing logic converts the ordinal values to normally distributed relative values (processing block 150). The normally distributed relative values are hereinafter referred to as “output data.” The items represented by the output data are referred to as output data items. Such conversion has the effect of “ordering” each of the dimensions of each output data item according to their relative position along a normal distribution curve. For instance, the ordering may be in terms of how many standard deviations a feature value of an output data item is away from the mean value in the respective dimension. As such, each feature value is separated by the distance of the feature value from the mean value and thus, allows subsequent applications to easily determine the distance between output data items. Unlike conventional techniques, which leave output data items in nominal values, the technique described above improves the accuracy of similarity determination because the normally distributed relative values indicate the relative positions between the output data items.

Furthermore, converting the ordinal scale values to normally distributed relative scale values assists in item separation by positioning each output item dimension value according to where the respective output item dimension value is in the normal distribution. If, for example, the output data happened to be very similar and very closely clustered in the FSM, the above conversion may separate these output data items evenly over the full range of a normal distribution. As such, the separation of the output data items may be improved, and hence, the determination of the degree of similarity between the output data items may also be improved.

In some embodiments, inter-dimensional operations may be performed on the output data items after conversion to normally distributed relative scale values. By converting the ordinal scale values to normally distributed relative scale values, each of features of the output data items are normalized, i.e. mapped to the same scale. Since the dimensions are mapped to the same scale, it is possible to perform operations between different dimensions. For example, the inter-dimensional operations may include inter-dimensional comparisons, inter-dimensional calculations, etc. Inter-dimensional operations may yield further interesting and useful information. For example, optimization may be achieved in finding distance measurements by adding values across dimensions and finding the manhattan distance (i.e., the distance between two points measured along axes at right angles) between two totals rather than between each individual dimension.

Finally, processing logic stores the normally distributed relative values in the database for later use (processing block 160). Processing logic may recommend some or all of the output data items to the user as the output data items are similar to the sample in terms of one or more of the features of the item. For example, when the user requests recommendation of items similar to the sample provided, processing logic may retrieve at least some of the output data items from the database to be presented to the user. Furthermore, the above technique may be applied to search engines in general. For instance, the above operations may be performed on a search term provided by the user to find items similar to the search term. Since more features of the search term may be processed using the multi-dimensional FSM, better search results may be generated using the operations described above. In some embodiments, the sample may be added to the collection of items in the database to expand the collection.

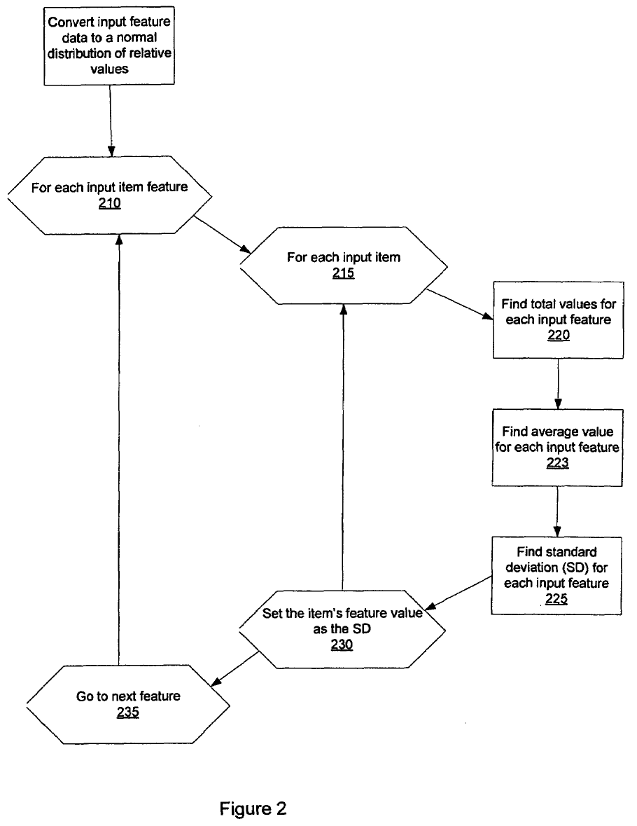

FIG. 2 illustrates one embodiment of a process to convert input feature data to a normal distribution of relative values. Processing logic analyzes the features of the input items. In one embodiment, for each input item feature (processing block 210), processing logic goes through each input item one by one (processing block 215).

In one embodiment, processing logic calculates the total value of an input feature of a set of items (hereinafter, the input items) (processing block 220). Then processing logic calculates an average value for the feature (processing block 223). Processing logic also calculates the standard deviation for the feature (processing block 225). Processing logic sets the feature value of the item as the standard deviation calculated (processing block 230). The process then returns to processing block 215 to repeat processing blocks 220-230 until all input items have been processed. Then processing logic transitions to processing block 235 to process another feature of the input items.

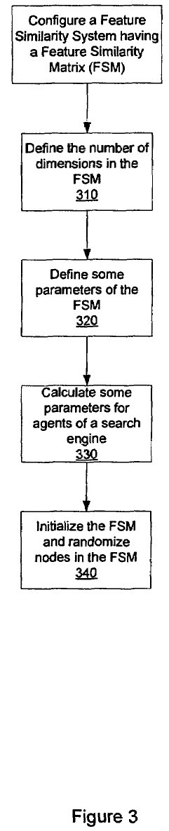

FIG. 3 illustrates one embodiment of a process to configure a feature similarity system having a FSM. Processing logic defines the number of dimensions in the FSM (processing block 310). As mentioned above, the FSM has multiple dimensions. A matrix node position is defined by a value in each dimension. Each node in the FSM has a set of weight values. Each of the weight values corresponds to a distinct feature of items to be processed by the feature similarity system. Processing logic may further define other parameters of the FSM (processing block 320). For instance, processing logic may define the number of levels in each dimension of the FSM, an optimum map neighborhood size in the FSM, etc. The map neighborhood size may be defined by a neighborhood radius in terms of a level or a range of levels in each dimension of the FSM. For instance, the map neighborhood size may be defined to be the size of the region having a neighborhood radius of one a in the FSM. In one example, the feature similarity system is used for finding music similar to a given sample. Then the weight values of each node in the FSM of the feature similarity system may correspond to audio frequency, power spectrum, strength of beat, etc. Processing logic may define the FSM to have ten (10) dimensions, each dimension having two (2) levels.

In one embodiment, the data similarity system is usable with a search engine having a number of agents to interact with a user and search for items based on the interaction with the user. One embodiment of the agents and the process performed by the search engine are described in the co-pending related U.S. Patent Application, U.S. patent application Ser. No. ______, entitled A METHOD AND AN APPARATUS TO PERFORM FEATURE WEIGHTED SEARCH AND RECOMMENDATION, filed of even date with this application. Processing logic may calculate one or more parameters used by the agents (processing block 330). For example, processing logic may calculate an optimal number of learning cycles, an optimal learning rate, etc. In some embodiments, some of these parameters may be tied to various metrics of the system, such as the number of items being processed (i.e., the size of the set of sample), the size of the matrix (i.e., the number of matrix nodes), the number of features per item, and the processing power available, etc. In some embodiments, the system mirrors human learning in that it takes a person time to learn but upon repeated presentation of samples, the person gradually learns to differentiate between items of a set. Initially, the person may learn the gross features quickly but then more and more slowly, the person learns the very fine details. The learning rate parameter generally works on the same principal, fast start, then gradually slowing down. The number of learning cycles may depend on the number of items being learnt, where more learning cycles are provided for learning more items. In some embodiments, the optimal number of learning cycles and the optimal learning rate may be determined in a trial and error fashion.

Finally, processing logic initializes the FSM by assigning weight values to each of the nodes in the FSM (processing block 340). In one embodiment, processing logic assigns random values to the nodes within the FSM. Alternatively, processing logic assigns weight values to each node based on a predetermined function. After initialization of the FSM, the data similarity mapping system is ready for processing input items and searching for additional items similar to the input items in terms of the features of the input items.

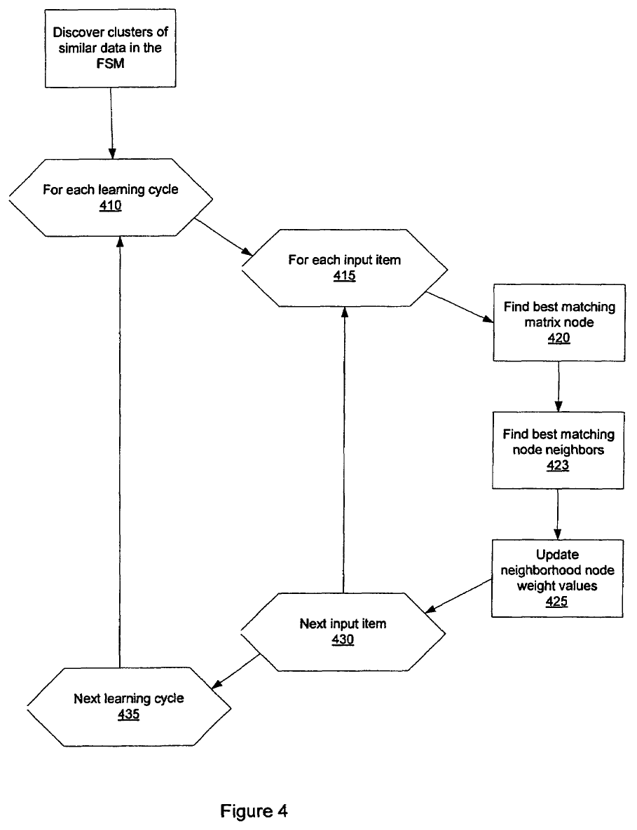

FIG. 4 illustrates one embodiment of a process to discover clusters of similar data in a multi-dimensional FSM in a feature similarity system. In each learning cycle, processing logic goes through each input item (processing blocks 410 and 415). For each input item, processing logic finds the best matching node (BMN) in the multi-dimensional FSM (processing block 420). The BMN is the matrix node whose individual weight values most closely match the input item's individual feature values. After finding the BMN, processing logic finds the neighbors of the BMN (a.k.a. neighborhood nodes) in the multi-dimensional FSM (processing block 423).

Finally, processing logic may update the weight values of the neighborhood nodes (processing block 425). When processing logic is done with the input item, processing logic transitions to processing block 430 and then to processing block 415 to repeat processing blocks 420, 423, and 425 for the next input item. When all input items have been processed, processing logic transitions to processing block 435 and then to processing block 410 to repeat processing blocks 415, 420, 423, 425, and 430 for the next learning cycle.

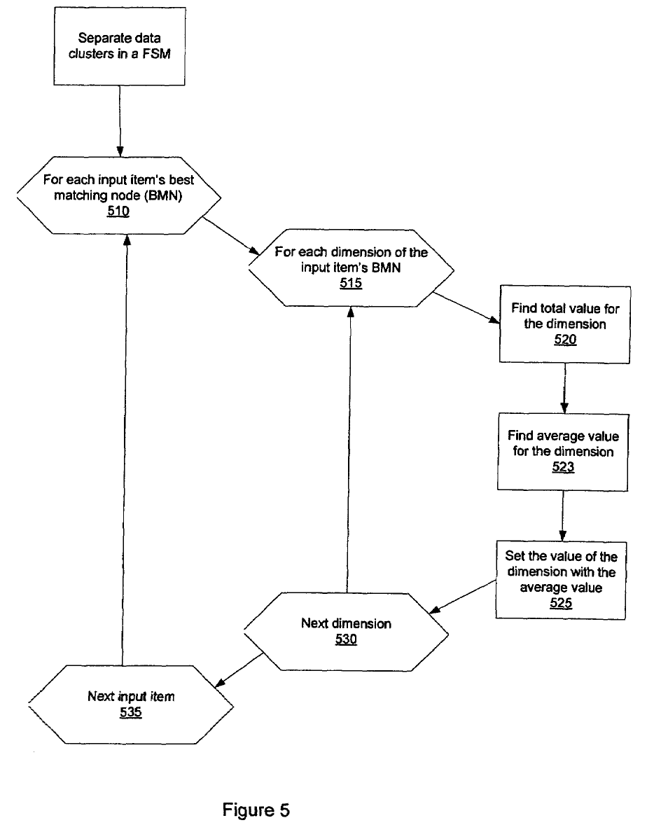

FIG. 5 illustrates one embodiment of a process to separate data clusters within a multi-dimensional FSM in a feature similarity system. For each best matching node (BMN) of an input item, processing logic analyzes each dimension of the BMN. In one embodiment, each dimension is analyzed one by one (processing blocks 510 and 515).

For each dimension, processing logic computes a total value in the dimension (processing block 520). Likewise, processing logic computes an average value in the dimension (processing block 523). Finally, processing logic sets the value of the item in the respective dimension to be the average value of the BMN (processing block 525).

When processing logic is done with the input item, processing logic transitions to processing block 530 and then to processing block 515 to repeat processing blocks 520, 523, and 525 for the next dimension of the BMN. When all dimensions have been processed, processing logic transitions to processing block 535 and then to processing block 510 to repeat processing blocks 515, 520, 523, 525, and 530 for the next input item's BMN.

To further illustrate the technique described above with reference to FIGS. 4 and 5, an example is provided below. Suppose a ten-by-two (10×2) FSM has been created during configuration of one embodiment of a feature similarity system. In other words, the FSM has ten dimensions, and each dimension has two levels, for example 0 and 1, which means there would be 2¹⁰ (512) matrix nodes created. The first node, second node, and the last node in the 10×2 FSM have the following positional coordinate values respectively: [0,0,0,0,0,0,0,0,0,0], [0,0,0,0,0,0,0,0,0,1], [1,1,1,1,1,1,1,1,1,1]. In some embodiments, a node has two properties, namely, the position of the node in the FSM and a set of weight values. The position of a node is defined by a set of positional coordinate values, one in each dimension of the FSM. For example, if the FSM has two dimensions, each with two levels, then there are 2² (4) nodes in the FSM, whose positions are (0,0), (0,1), (1,0), and (1,1). In addition to the position, a node has a set of weight values as well. The number of weight values of a node is the same as the number of feature values of an input data item. For instance, if the input data is [0.5, −0.1, 0.4], then the weight values maybe [1.04, −2,−1]. Note that the number of weight values of a node may or may not be the same as the number of dimension of the FSM.

In some embodiments, the weight values of the nodes in the FSM are initialized with random values. The random values may be within the same general range as the input data. For example, if the input data is normalized using Z score values which are generally in the range of −2.0 to 2.0, then the initial random node values in each dimension is set between −2.0 and 2.0.

As discussed earlier, other parameters may be set during configuration. In the current example, the learning rate is set to be 1.0 divided by the size of the FSM, i.e., 1.0/(10×2)=0.05. The neighborhood radius, which defines a region around a node of the FSM, is set to be the radius of the FSM, i.e., (10×2)/2=10. These values are exemplary, and may, of course, be varied. Furthermore, the neighborhood Gaussian curve parameters may be set during configuration. For example, parameters may be set to define the curve as a wide curve, a narrow curve, an overlapping “Mexican hat” curve, etc. In some embodiments, the Gaussian curve is used to define a percentage of neighborhood membership as opposed to either being a neighbor or not. Varying the parameters of the curve to make the curve wider or narrower effectively changes the size of the radius. With a narrow curve, close members may have a large membership value, but then as the neighborhood membership percentage may quickly drop to a very small value as the curve moves further away from the BMN. However, if a wide curve is used, the membership percentage may gradually reduce as the curve moves further away from the BMN. The above two patterns may produce either very tight members or more relaxed members. If the data is very precise and defined, such as measurements, then a narrow curve may be used. However, if the data is relatively fuzzy, such as music, then a wider curve may be used.

After configuring the FSM, the FSM may be trained by the following operations to discover a cluster of data based on an item. The item may be a sample input. Alternatively, the item may be selected at random from a set of data items. Then every node of the FSM is checked to find the best matching node (BMN), which is the matrix node whose individual weight values most closely match the input item's individual feature values. For instance, the data of an item may be [0.3, 1.2, −0.4]. A node at position [1, 0, 0, 0, 1, 0, 1, 0, 1, 1] with the weight values of [0.3, 1.1, −0.3] may be identified as the closest to the item. Thus, the manhattan distance of the item from the node is about 0.2. Note that the distance between the item and the node may be measured in a number of ways, such as standard Euclidean or manhattan distances between each item feature and node weight.

After finding the BMN, nodes within the region defined by the neighborhood radius may be found. These nodes are referred to as the BMN neighbors. In the current example, the BMN is at the position [1,0,0,0,1,0,1,0,1,1] and the neighborhood radius is 10. Thus, those nodes within a distance of 10 may be included in the list of the BMN neighbors. For instance, the node at position [1,0,0,0,1,0,1,0,0,0] has a distance of 2 from the BMN using the manhattan distance technique, and thus, this node is one of the BMN neighbors.

After finding the BMN neighbors, the FSM node values within the BMN neighborhood may be updated. The amount of update may be determined by the distance from the BMN, where distance 0=1.0 with a Gaussian curve of values from the BMN. As mentioned above, the Gaussian curve is used to define a percentage of neighborhood membership as opposed to either being a neighbor or not. That percentage figure may be a value between 0.0 and 1.0 (effectively 0% membership and 100% membership, i.e., the BMN itself). This value may be further decreased by multiplying by the learning rate, which itself may change over time. In some embodiments, the learning rate follows an inverse logarithmic curve, so the learning rate makes larger changes initially, followed by ever decreasing changes.

In some embodiments, once the BMN has been found, the feature similarity system changes the values of the BMN by a small amount to become more like the item the BMN is close to. Also, values of some or all of the nodes in the neighborhood of the BMN may be modified to be more like the item that the corresponding node is close to. Furthermore, the farther the item is from a node from the BMN, the less the values of the node may be modified.

In one embodiment, the series of operations described above are performed in a learning cycle. Over many learning cycles (such as hundreds, or thousands), this gradual process of incrementally changing the node values eventually may reach a point where an item, when presented, may always match to one specific node in the FSM. When substantially all items reach this point, the FSM is trained. As such, the feature similarity system may make large initial changes so gross features can be mapped, followed by ever smaller changes that fine tune the values of the nodes as the nodes gradually settle into their near final states. In one embodiment, such training may be performed prior to the FSM being available to users.

By updating the BMN as well as the BMN neighbors in each learning cycle to reduce the difference between the nodes (i.e., the BMN and the BMN neighbors) and the corresponding items, the nodes gradually become ever more similar to their neighbors. In other words, similar items may gradually map to ever closer nodes, thus, achieving the clustering of similar items.

Note that some of the nodes in the FSM may be mapped to more than one item depending on the size of the FSM and the size of the set of items. Thus, in some embodiments, the final node positions are averaged. For instance, if a FSM has a size of 1024 nodes and there are 102,400 items, then each node may be mapped to about 100 items. Therefore, the items mapped to the same node may be further separated so that only one item is mapped to one node. To separate the items, sub-nodes may be created. For instance, a node position [1,0,0,0,1,0,1,0,0,0] may map to three separate items. To separate these three items, in one embodiment, three sub-nodes may be created from the node position [1,0,0,0,1,0,1,0,0,0], such as [0.8, 0.2, 0.2, 0.2, 0.7, 0.1, 0.9, 0.2, 0.1, 0.3], [0.7, 0.2, 0.2, 0.1, 0.6, 0.1, 0.8, 0.2, 0.2, 0.3], and [0.9, 0.1, 0.1, 0.2, 0.7, 0.2, 0.9, 0.2, 0.3, 0.3].

To average final node positions, in one embodiment, a weighted mean or a weighted average is used. In one embodiment, the new sub-position values may be distributed using Z score. At this point, in terms of node positions, there are clusters of similar items, generally each item mapped to a unique position in the FSM. Depending on the dimensions of the FSM and the final node weight values, the averaged position value may be a variety of different values. However, the averaged position value may be further normalized to be within a set range in order to generate the final position values in a standardized format. In some embodiments, Z score is used to place values within a predetermined range, such as −2.0 to 2.0. Note that, theoretically, the range is from minus infinity to positive infinity. But in practice, in one embodiment, the values may rarely be above 3.0 or below −3.0. One advantage of restricting the values to be within a predetermined range is that other applications and/or services using these values may be assured of the range of the values even if the data is continually updated as new items are processed. More details of normalizing the position values are discussed below.

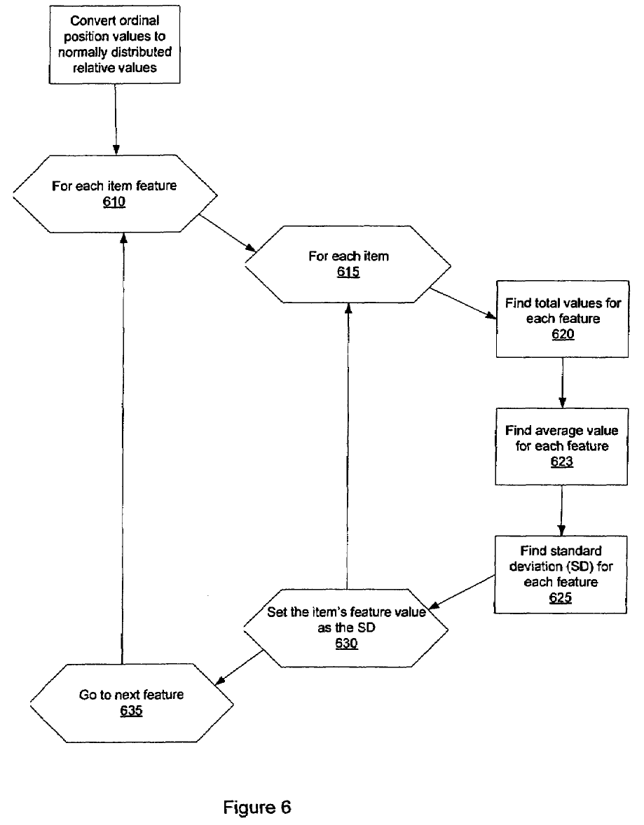

FIG. 6 illustrates one embodiment of a process to convert ordinal position values of items to be output from a feature similarity system into normally distributed relative values. For each feature of the items, which corresponds to a unique dimension in a multi-dimensional FSM, processing logic processes each item one by one (processing blocks 610, 615).

For each item, processing logic computes a total value for each feature of the item (processing block 620). In one embodiment, processing logic computes an average value (a.k.a. a mean value) for each feature of the item (processing block 623). Processing logic computes the standard deviation for the feature of the item (processing block 625).

Processing logic sets the corresponding feature value of the item as the standard deviation (processing block 630). Note that the standard deviation is the same as the Z score discussed above. Then processing logic transitions back to processing block 615 to repeat processing blocks 620, 623, and 625 for another item. When processing logic is done with all items, processing logic transitions to processing block 635 to repeat the above operations on the next feature of the items.

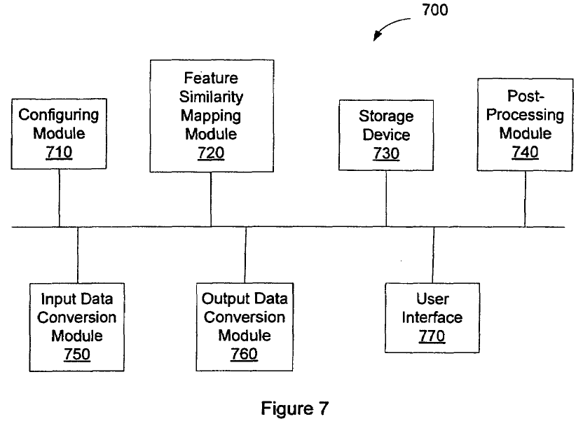

FIG. 7 illustrates a functional block diagram of one embodiment of a feature similarity system. The feature similarity system 700 includes a configuring module 710, a feature similarity mapping module 720, a storage device 730, a post-processing module 740, an input data conversion module 750, an output data conversion module 760, and a user interface 770. Note that other embodiments of the feature similarity system 700 may include more or fewer components than those shown in FIG. 7.

In some embodiments, the configuring module 710 is operable to configure a FSM in the feature similarity system 700. The FSM has a plurality of dimensions, each of the dimensions corresponding to a distinct feature of items to be mapped to the FSM. Furthermore, the configuring module 710 is operable to initialize the FSM. In one embodiment, the configuring module 710 may initialize the FSM with random values.

The user interface 770 permits a user to input an item (a.k.a. a sample) and to receive the item from the user. Via the user interface 770, a user may input to the feature similarity system 700 the item that the user is interested in. The item from the user is provided to the input data conversion module 750. In some embodiments, the input data conversion module 750 determines values of features of the item. For example, the input data conversion module 750 may look up the values of the features of the item from a database. Alternatively, the input data conversion module 750 may evaluate the item and assign values to the features of the item based on the evaluation. For example, if a user uploaded a song file in MP3 format, then the file may be run through some audio processing software in the input data conversion module 750 to extract various parameters of numeric audio data, such as power spectrum, frequency components, etc. This audio processing software outputs the data in a format the feature similarity system can read, such as in the format of a database input or an Extensible Markup Language (XML) file. In some embodiments, the values of the features of the item are expressed as a collection of variable scale values, such as [0.5, 11.4, 9]. The input data conversion module 750 may convert the values of the features of the item from variable scale values into relative scale values with a normal distribution. The relative scale values of the features of the item are provided to the feature similarity mapping module 720 to be further processed.

In some embodiments, the feature similarity mapping module 720 maps the sample onto the FSM and discovers one or more clusters of data in the FSM that are close to the location of the sample in the FSM. In other words, the clusters of data in the FSM which are closest to the relative scale values of the item represent items that are similar to the sample. In one embodiment, at least some or all of the clusters of data are converted by the output data conversion module 760. In one embodiment, the clusters of data are converted from nominal scale values into ordinal scale values. Alternatively, the clusters of data are converted from variable nominal scale values into relative ordinal scale values. The converted data may be stored in the storage device 730 for later use. In one embodiment, the results may be displayed to user via user interface 770.

In some embodiments, the converted data from the output data conversion module 760 are further processed by the post-processing module 740. For example, the post-processing module 740 may perform inter-dimensional operations on the converted data. Details of some embodiments of inter-dimensional operations have been discussed above.

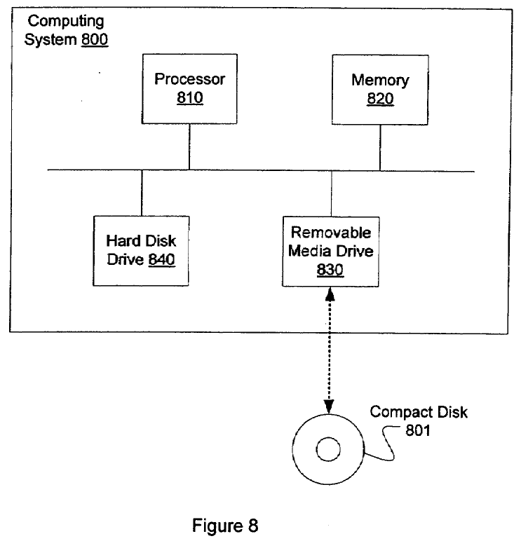

FIG. 8 illustrates a computing system that may be used to perform some or all of the processes described above according to some embodiments. In one embodiment, the computing system 800 includes a processor 810 and a memory 820, a removable media drive 830, and a hard disk drive 840. Note that various embodiments of the computing system 800 may include more or less components as illustrated in FIG. 8. In one embodiment, the processor 810 executes instructions residing on a machine-readable medium, such as the hard disk drive 840, a movable medium (e.g., a compact disk 801, a magnetic tape, etc.), or a combination of both. The instructions may be loaded from the machine-readable medium into the memory 820, which may include Random Access Memory (RAM), dynamic RAM (DRAM), etc. The processor 810 may retrieve the instructions from the memory 820 and execute the instructions to perform operations described above.

Some portions of the preceding detailed description are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description above. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A computer-implemented method comprising:
mapping a plurality of input data items onto a feature similarity matrix (FSM) in a feature similarity system, the FSM having a plurality of dimensions greater than three, a plurality of nodes, and for each of the plurality of nodes, a plurality of weights, each of the input data items having a plurality of features and each of the plurality of features corresponding to a distinct one of the plurality of weights of a distinct one of the plurality of nodes; and
incrementally repositioning the plurality of nodes in the FSM so that input data items with a plurality of similar features are mapped to incrementally closer nodes until the input data items reach a predetermined distance.

2. The method of claim 1, wherein each of the plurality of dimensions has a plurality of levels, and each of the plurality of nodes has a value at one of the plurality of levels in each of the plurality of dimensions.

3. The method of claim 1, further comprising:
converting mapped position values of the plurality of input data items from nominal scale values into ordinal scale values.

4. The method of claim 3, further comprising:
converting the ordinal scale values into normally distributed interval scale values.

5. The method of claim 4, further comprising:
performing inter-dimensional operations on the mapped position values of the plurality of the input data items.

6. The method of claim 1, further comprising:
converting values of the plurality of features of the plurality of input data items from arbitrarily ranged and scaled values into normally distributed interval scale values.

7. The method of claim 6, further comprising:
performing inter-dimensional operations on values of the plurality of features of the plurality of the input data items.

8. The method of claim 1, further comprising:
automatically configuring the feature similarity system.

9. The method of claim 8, wherein configuring the feature similarity system comprises:
defining the FSM from a plurality of properties derived from analyses of the plurality of input data items; and
initializing the FSM by assigning the plurality of weight values to each of the plurality of nodes in the FSM.

10. The method of claim 1, further comprising:
storing in a database positional values of the mapped plurality of input data items.

11. The method of claim 10, further comprising:
in response to a request from the user to perform a search for items similar to an input item, retrieving at least one of the one or more mapped plurality of input data items from the database; and
presenting at least one of the mapped plurality of input data items to the user as a result of the search.

12. The method of claim 1, wherein the plurality of input data items include a piece of music and the plurality of features include audio frequency of the piece of music.

13. A machine-accessible medium that stores instructions which, if executed by a processor, will cause the processor to perform operations comprising:
mapping a plurality of input data items onto a multi-dimensional feature similarity matrix (FSM) in a feature similarity system, the FSM having a plurality of dimensions, a plurality of nodes, and for each of the plurality of nodes, a plurality of weights, each of the plurality of input data items having a plurality of features and each of the plurality of features corresponding to a distinct one of the plurality of weight of a distinct one of the plurality of nodes; and
incrementally repositioning the plurality of nodes in the FSM so that input data items with a plurality of similar features are mapped to incrementally closer nodes until the input data items reach a predetermined distance.

14. The machine-accessible medium of claim 13, wherein each of the plurality of dimensions has a plurality of levels, and each of the plurality of nodes has a value at one of the plurality of levels in each of the plurality of dimensions.

15. The machine-accessible medium of claim 13, wherein the operations further comprise:
converting the mapped position values of the plurality of input data items from nominal scale values into ordinal scale values.

16. The machine-accessible medium of claim 15, wherein the operations further comprise:
converting the mapped position ordinal scale values into normally distributed interval scale values.

17. The machine-accessible medium of claim 16, wherein the operations further comprise:
performing inter-dimensional operations on the mapped position values of the plurality of input data items.

18. The machine-accessible medium of claim 13, wherein the operations further comprise:
converting values of the plurality of features of the plurality of input data items from arbitrarily ranged and scaled values into normally distributed interval scale values.

19. The machine-accessible medium of claim 18, wherein the operations further comprise:
performing inter-dimensional operations on values of the plurality of features of the plurality of the input data items.

20. The machine-accessible medium of claim 13, wherein the operations further comprise:
automatically configuring the feature similarity system.

21. The machine-accessible medium of claim 20, wherein configuring the feature similarity system comprises:
defining the FSM from a plurality of properties derived from analyses of the plurality of input data items; and
initializing the FSM by assigning the plurality of weight values to each of the plurality of nodes in the FSM.

22. The machine-accessible medium of claim 13, wherein the operations further comprise:
storing in a database positional values of the mapped plurality of input data items.

23. A system comprising:
a first storage module to store a feature similarity matrix (FSM) having three or more dimensions; and
a feature similarity mapping module to map a plurality of input data items onto the FSM, each of the plurality of input data items having a plurality of features, each of the plurality of features corresponding to a distinct one of a plurality of matrix node weights, and to position the data in the FSM, the data position corresponding to input data items having one or more features similar to one or more of the plurality of matrix node weights.

24. The system of claim 23, further comprising:
a first output data conversion module to convert the mapped position values of the plurality of input data items from nominal scale values into ordinal scale values.

25. The system of claim 23, further comprising:
a second output data conversion module to convert the mapped position values of the plurality of input data items from ordinal scale values into interval scale values.

26. The system of claim 25, further comprising:
a first post-processing module to perform inter-dimensional operations on the interval scale values.

27. The system of claim 23, further comprising:
a user interface to prompt a user to input at least one of the plurality of input data items, to receive the at least one of the plurality of input data items from the user, and to present a plurality of data item recommendations to the user.

28. The system of claim 23, further comprising:
a first input data conversion module to convert values of the plurality of features of the plurality of input data items from variable scale values into interval scale values with a normal distribution.

29. The system of claim 28, further comprising:
a second post-processing module to perform inter-dimensional operations on the values of the plurality of features of the plurality of input data items.

30. The system of claim 23, further comprising:
a configuring module to automatically configure the feature similarity system.

31. The system of claim 30, wherein the configuring module is further operable to define the FSM from a plurality of properties derived from analyses of the plurality of input data items and to initialize the FSM by assigning a plurality of weight values to each of a plurality of nodes in the FSM.

32. The system of claim 23, further comprising:
a second storage module to store mapped positional values of the plurality of input data items.
